(19) United States
(12) Patent Application Publication
(10) Pub. No.: US 2017/0021590 A1
(43) Pub. Date: Jan. 26, 2017

(54) FLEXIBLE PANEL

(71) Applicant: TenCate Performance Composites, Carmarillo, CA (US)

(72) Inventors: Mark T. Jennings, Newbury Park, CA (US); Robert W. Reynolds, Ventura, CA (US)

(73) Assignee: TenCate Performance Composites, Camarillo, CA (US)

(21) Appl. No.: 15/216,158

(22) Filed: Jul. 21, 2016

Related U.S. Application Data
(60) Provisional application No. 62/195,120, filed on Jul. 21, 2015.

(51) Int. Cl. B32B 7/00; B32B 3/00

(52) U.S. Cl. CPC B32B 7/005; B32B 3/00; B32B 2307/54; B32B 2307/514; B32B 2307/546; B32B 2607/00

(57) ABSTRACT

A flexible panel has an area, a lateral direction, and a longitudinal direction. The flexible panel includes a plurality of panel layers attached on top of each other. Each of the plurality of panel layers has an area, and at least some of the plurality of panel layers include a plurality of fibers encapsulated in a binder material in a fiber orientation. In some aspects, the flexible panel includes a rigid zone having a rigid zone flexibility and a flex zone having a flex zone flexibility different from the rigid zone flexibility. In some cases, at least one of the plurality of panel layers or the fiber orientation of the panel layers is different between the rigid zone and the flex zone.

### REFERENCE TO RELATED APPLICATIONS

This application claims the benefit of U.S. Provisional Application Ser. No. 62/195,120, filed on Jul. 21, 2015 and entitled FLEXIBLE PANEL. The '120 application is hereby incorporated in its entirety by this reference.

### FIELD OF THE INVENTION

The field of the invention relates to selectively reinforced flexible panels, and more particularly to articulating flexible panels having varying physical properties in different areas of the panel.

### BACKGROUND

Articulating supports, such as those used below mattresses to form a frame in articulating or adjustable beds, generally comprise a plurality of panels, usually plywood, joined together at hinges to provide areas of relative stiffness and areas of articulation. These supports are often heavy and can create pressure points or areas of discomfort around the hinges and panel ends, result in “bridging” because mattresses may not follow the sharp changes in direction at the hinges. Moreover, such supports may also require special flame and/or fire resistant covers.

Other supports may be made of a single sheet of plastic. However, such sheets lack adequate fatigue resistance and only provide a single stiffness. The resulting panels are often too stiff in areas where flex is desirable, such as the articulation points, and too flexible in areas where stiffness is desirable, such as between the articulation points to provide adequate support.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments of the present invention, a flexible panel includes at least two zones—a rigid zone having a flexibility and a flex zone having a flexibility. The flexibility of the rigid zone is less than the flexibility of the flex zone. In some embodiments, the panel is a composite panel formed of a variety of layers. The flexibility of the various zones on the panel can be controlled by controlling the number of layers within each zone as well as the orientation of the layers within the zones. In some cases, the flexible panel includes a base composite onto which additional reinforcements layers may be added in selected locations and orientations to selectively reinforce the base composite and create a flexible panel having the desired physical properties in the desired zones or areas on the panel.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1A is a perspective view of a flexible panel according to examples of the present invention.

FIG. 1B is another perspective view of the flexible panel of FIG. 1A according to examples of the present invention.

FIG. 2 is an exploded assembly view of a flexible panel according to examples of the present invention.

FIG. 3 is an exploded assembly view of a flexible panel according to examples of the present invention.

FIG. 4 is an exploded assembly view of a flexible panel according to examples of the present invention.

FIG. 5 is an exploded assembly view of a flexible panel according to examples of the present invention.

FIG. 6 is an exploded assembly view of a flexible panel according to examples of the present invention.

FIG. 7 is a perspective view of a roll of a layer for use in a flexible panel according to examples of the present invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

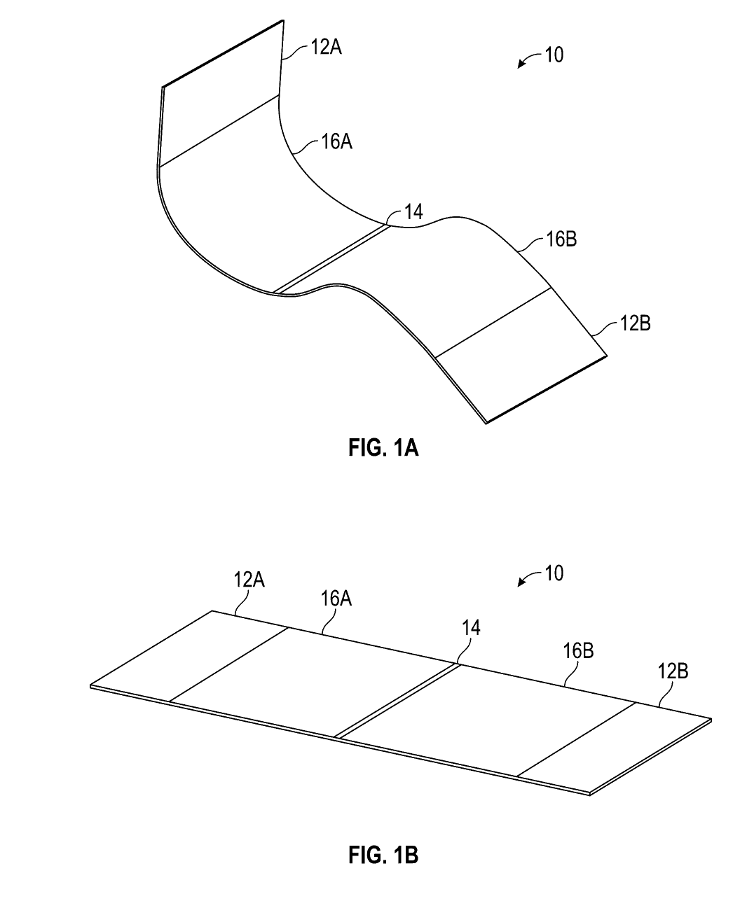

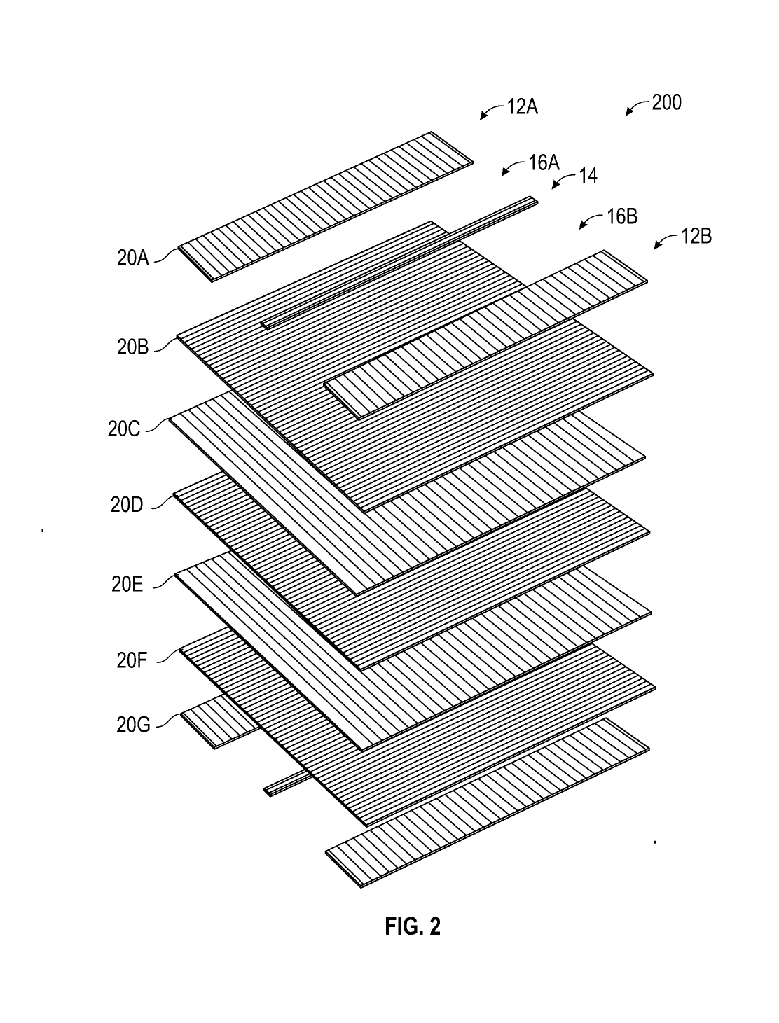

Embodiments of the invention provide a flexible panel that uses selective reinforcement to impart different strength and stiffness characteristics at desired locations on the panel. FIG. 1A illustrates an embodiment of such a flexible panel 10 in a curved orientation (as it might be if in use), and FIG. 1B illustrates the flexible panel 10 in a flat orientation. The flexible panel 10 illustrated in FIGS. 1A and 1B has five zones—rigid zones 12A and 12B, attachment zone 14, and flex zones 16A and 16B. While the flexible panel 10 of FIGS. 1A and 1B is divided into five zones, in various other examples, the flexible panel 10 could have as few as two zones to as many zones as desired or required for a particular application. Use of the terms “rigid zone” and “flex zone” is intended to mean that the rigid zone is more rigid than the flex zone and that the flex zone is more flexible than the rigid zone. It is not meant to suggest that the rigid zone cannot have some degree of flexibility or that the flex zone cannot have some degree of rigidity.

In one non-limiting example, the flexible panel 10 may be of particular use in an adjustable bed. Adjustable beds may feature moveable arms or supports between the bed base and the mattress. The moveable supports, which are typically powered by electric motors, feature a number of links and hinges to articulate the mattress between a supine position, an articulated or upright position, and any position in between. To maintain comfort, a support structure is necessary between the mattress and the moveable supports to prevent areas of discomfort, pressure points, or damage to the mattress from the moveable support components and linkages. The flexible panel 10 is well suited for use in such applications; however, their use is certainly not limited to such applications. Rather, it is contemplated that embodiments of the panels disclosed herein may be used in any application requiring panels having different physical properties at different locations on the panel.

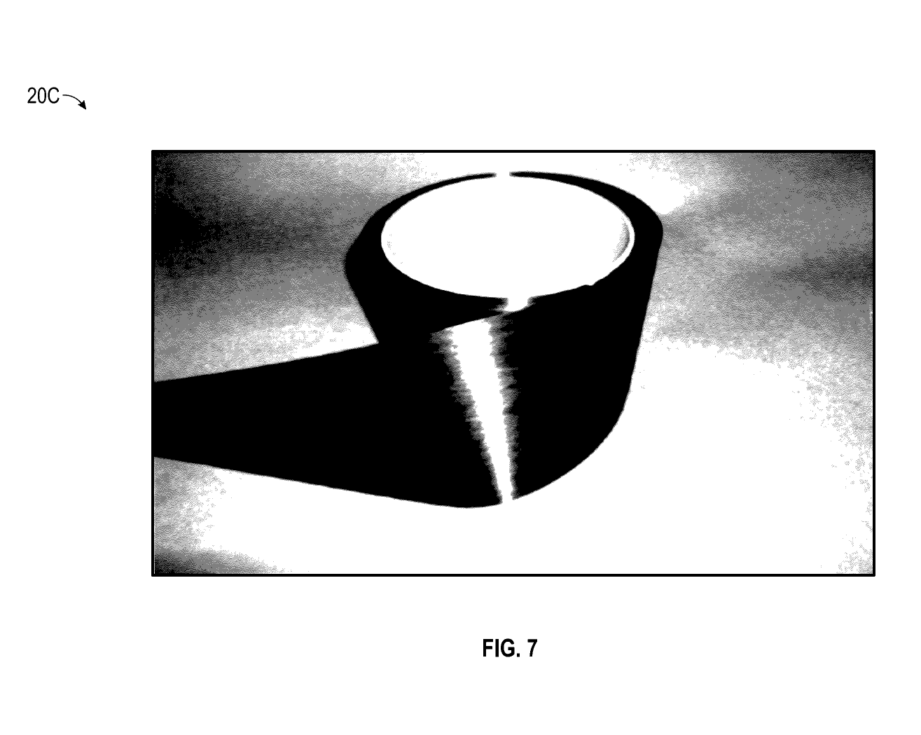

The flexible panel 10 may be manufactured from a variety of different components or materials, and may include additional features to enhance or further control the strength and stiffness profile of the flexible panel 10. In some embodiments, the flexible panel 10 may be formed of a single layer, but in other embodiments, the flexible panel 10 may be formed of multiple panel layers. In some embodiments, the panel layers are formed of a reinforcement material embedded within an encapsulating or binder material. For example and without limitation, the panel layers may consist of fiber reinforced polymeric materials (e.g., thermoplastic or thermoset plastics reinforced with carbon fibers, glass fibers, aramid fibers, basalt fibers, etc.). In some embodiments, at least some of the panel layers are formed of glass fibers encapsulated within a thermoplastic binder or resin. For example, the flexible panel 10 may be constructed from a material comprising PA 6 binder (Nylon) with embedded and continuous glass fibers. In certain cases, the material may contain 60% glass fibers and 40% PA 6 binder, although in various other embodiments, other percentages may be utilized. It will further be appreciated that various other materials may be used as the binding material, including, but not limited to Polyethylene terephthalate (PET), Polyethylene terephthalate glycol-modified (PETG), polypropylene, various other polymers, and various other suitable binding material. The fibers may be pre-impregnated with resin (referred to as “prepreg”), or the binder or resin may be added during manufacture to bind the fibers together. In certain embodiments, the layers for use in the flexible panel 10 may be provided in the form of tape (i.e., long strips of material), such as illustrated in FIG. 7, or in sheets.

Some embodiments of the flexible panel 10 are formed by stacking various panel layers and laminating or otherwise fusing them together (such as with heat, pressure, and/or various other processes) to form a composite panel, as described in detail below with reference to FIGS. 2-6. In some examples, all of the layers of a flexible panel 10 may be the same. In other examples, layers of different materials or characteristics may also be included. For example, as described in detail below with reference to FIG. 4-6, in some embodiments, layers of foam, honeycomb, films, or other core materials may form at least one layer of the flexible panel 10.

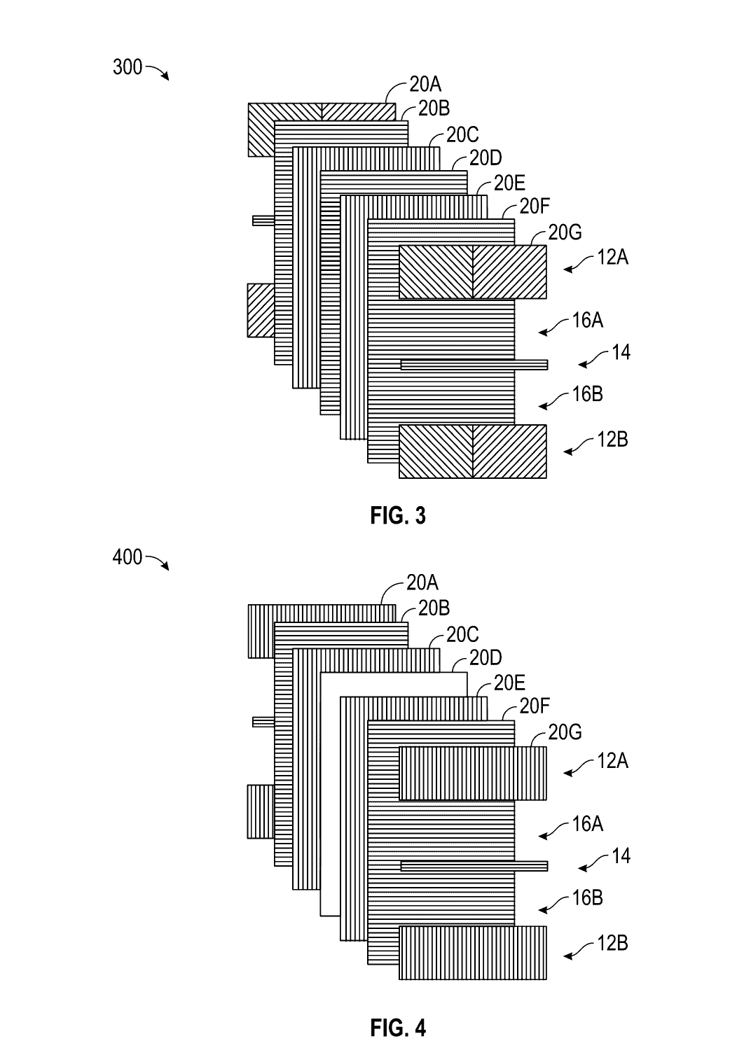

The fibers within a layer may be provided in the layer uni-directionally (all oriented in the same axial direction), bi-directionally (oriented in two axial directions), multi-directionally (oriented in more than two axial directions), or randomly. In some embodiments, such as illustrated in FIG. 2, all of the layers in the flexible panel 10 are the same in that all of the layers consist of uni-directional fibers in that the fibers within each layer are oriented in the same axial direction. Note that the lines provided on each panel layer shown in the Figures represent the directionality of the fibers within each panel layer. However, in various other examples, the fiber orientation of each of the layers of the flexible panel 10 need not be the same. For example and without limitation, as illustrated in FIG. 3, one layer of a flexible panel 10 could have fibers all oriented in the same direction (i.e., uni-directionally) while another layer of the same flexible panel 10 could have fibers oriented in different axial directions within the layer (see, e.g., layer 20G).

The type and number of layers as well as the relative orientation of the individual layers within the flexible panel 10 affect the stiffness/flexibility of the flexible panel 10. Thus, flexible panels 10 may be customized to have the desired physical properties by controlling these variables. For example and without limitation, FIGS. 2-6 illustrate alternative and non-exhaustive panel constructions 200, 300, 400, 500, and 600, respectively, that can be used to create the five zones 12A, 12B, 14, 16A, and 16B of the flexible panel 10 of FIG. 1.

Referring to FIG. 2, in some examples a panel construction 200 for the flexible panel 10 has seven layers 20A-G, each consisting of unidirectional fibers. In these examples, all of the layers 20A-G are constructed from the same type of material, although they need not be. It will also be appreciated that although seven layers 20A-G are illustrated in FIG. 2, in various other examples, any desired number of layers 20 can be utilized to vary the characteristics of a particular zone of the flexible panel 10.

The rigid zones 12A and 12B each include the layers 20A-G. As illustrated in FIG. 2, in some examples, the fibers of each adjacent layer within the zone, such as adjacent layers 20A and 20B, are offset 90° relative to an adjacent layer. Flex zones 16A and 16B each includes layers 20B-F, again with the fibers of adjacent layers offset 90°. The attachment zone 14 includes layers 20A-G and may be identical to rigid zones 12A and 12B except that the fibers of layers 20A and 20G are aligned with the orientation of the fibers of their adjacent layers, layers 20B and 20F, respectively. In various other examples, the fibers of adjacent layers may be offset relative to fibers of an adjacent layer by various other angles. In various aspects, adjacent zones, such as rigid zone 12A and flex zone 16A or flex zone 16B and attachment zone 14, have a different number and/or rotational orientation of layers so as to impart different properties (such as levels of stiffness, strength, flexibility, etc.) within each zone.

The flexible panel 10 has greater strength and stiffness in the direction of the reinforcement fibers than in a direction that is orthogonal to the direction of the reinforcement fibers. This directional dependence for stiffness, along with varying the number of layers in a zone, can be used to tailor the support characteristics of a particular zone. For example, in FIG. 2, rigid zones 12A and 12B have more layers (layers 20A-G) compared to the flex zones 16A and 16B, which only have layers 20B-F. Moreover, the fibers in more of the layers 20A-G that form rigid zones 12A and 12B are oriented at 90° (i.e., in the longitudinal direction of the flexible panel 10), specifically in layers 20A, 20C, 20E, and 20G. The rigid zones 12A and 12B thus will be stiffer and stronger in the longitudinal direction than in the lateral (0°) direction. In contrast, the fibers in fewer of the layers 20B-F forming flex zones 16A and 16B are oriented in the longitudinal direction, and thus flex zones 16A and 16B are more flexible in the longitudinal direction and thus more easily bent in the longitudinal direction to shape or conform as desired. However, because flex zones 16A and 16B have more fibers oriented at 0° (the lateral direction of the flexible panel 10) than at 90° (see layers 20B, 20D, and 20F), flex zones 16A and 16B thus have greater stiffness in the lateral direction (the 0° direction). The difference in stiffness is due to more layers being arranged in the 0° direction for greater lateral strength (e.g. layers 20B, 20D, and 20F of the flex zones 16A and 16B are oriented in the 0° direction compared to layers 20C and 20E oriented in the 90° direction).

As applied to an adjustable bed or similar product, the layers 20 for flexible panel 10 may be advantageous because it provides for some flexibility in the longitudinal direction to allow the bed to articulate, but gives extra support in the lateral direction so that the bed will not deflect laterally for a user laying on the bed or sitting at the edge of the bed. Rigid zones 12A and 12B incorporate extra reinforcement layers (e.g. layers 20A and 20G) in the longitudinal direction to resist longitudinal bending. Such may correspond to the areas of an adjustable bed that typically remain planar or substantially planar even when the bed is in an articulated position. Flex zones 16A and 16B, however, will flex to move and/or conform the support structure or frame, and consequently the mattress, into an articulated position. The attachment zone 14 is designed to provide additional strength in the area of the flexible panel 10 where it will be attached to the moveable supports of an adjustable bed. The attachment zone 14 may require a different strength and/or stiffness profile depending on the means of attachment between the flexible panel 10 and the moveable supports and framework.

FIGS. 3-6 show alternate panel constructions 300, 400, 500, and 600, respectively, for flexible panel 10. Panel construction 300 of FIG. 3 is identical to panel construction 200 of FIG. 2 except that layers 20A and 20G include bi-directional fibers. In the present example, the fibers in layers 20A and 20G are oriented 45° relative to each other within each layer, although then need not or may be at various other angles relative to each other.

The panel construction 400 of FIG. 4 is identical to the panel construction 200 of FIG. 2 except that the layer 20D is constructed from a different material than the other layers. As a non-limiting example, in some cases, the layer 20D is a thermoplastic film or core. In other examples, the layer 20D (or another layer acting as a core) may be constructed from layers of foam, honeycomb, films, organic materials such as Balsa, micro-spheres, or various other suitable core materials, depending on particular application, that may still allow the flexible panel 10 to flex.

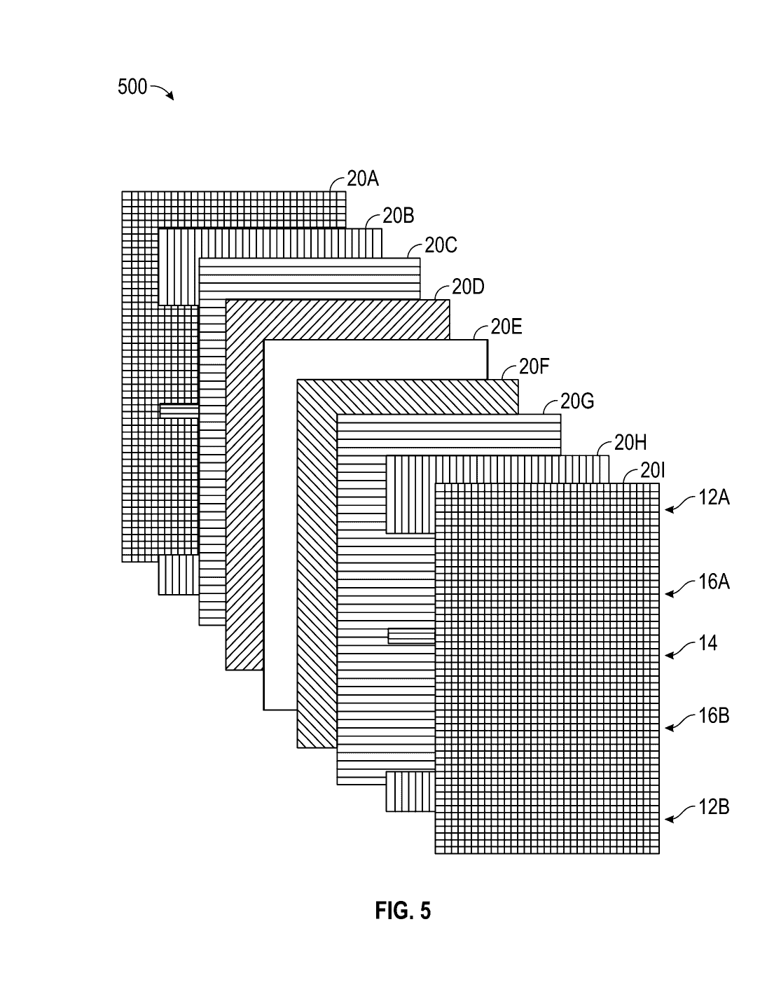

FIG. 5 illustrates a panel construction 500 with nine layers 20A-I. Layer 20E is a core layer constructed from a thermoplastic film or core (similar to the layer 20D of panel construction 400). Outer layers 20A and 201 are constructed from a woven fiber reinforced thermoplastic layer. In some examples, if a layer is a woven layer, the fabric may be impregnated or “wetted out” with a compatible or similar polymer, although it need not be. Layers 20D and 20F each contain uni-directional fibers but the fiber orientation of layers 20D and 20F is angularly offset by 45° and 135° from the fiber orientation of respective adjacent layers 20C and 20G (instead of by 90° as illustrated in FIG. 2). In some examples, as illustrated in FIG. 5, two layers, such as layers 20D and 20F are off-axis relative to each other (i.e., the directionality of the fibers in layer 20D is 90° relative to the directionality of the fibers in layer 20F) to balance the forces/tensions within the flexible panel 10 so as to create a flat panel devoid of skewing.

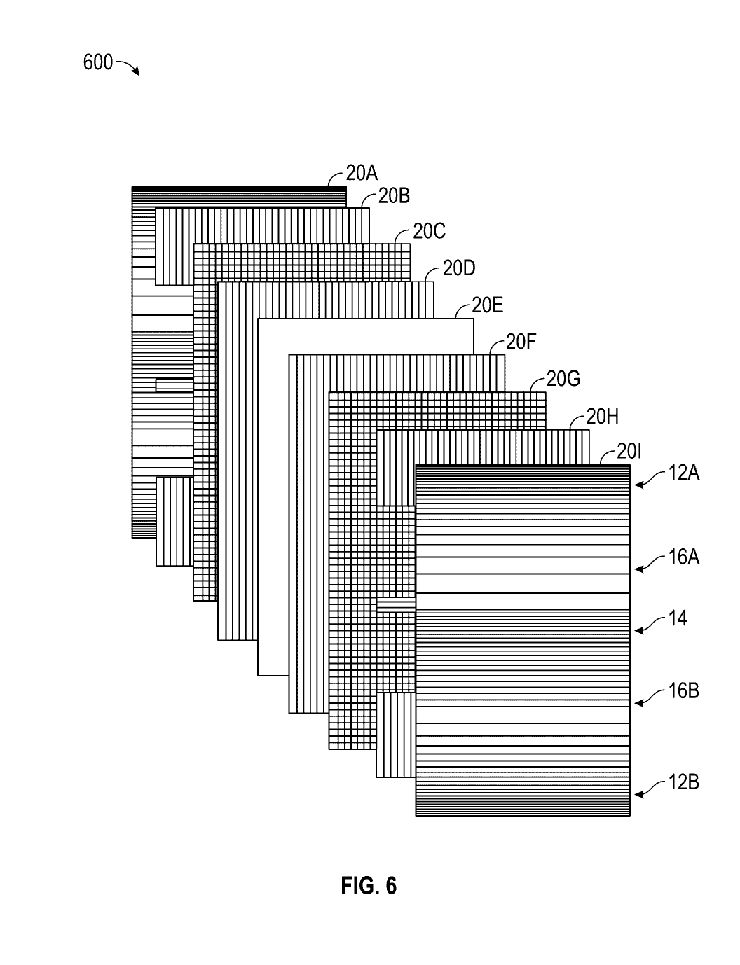

FIG. 6 illustrates another example of a panel construction 600. Panel construction 600 includes nine layers 20A-I. In some examples, the layer 20E is a core layer constructed from a thermoplastic film or core and layers 20C and 20G are woven fiber reinforced thermoplastic layers. In some cases, outer layers 20A and 201 are decorative layers. For example and without limitation, in some cases, the decorative layers include decorative materials, decorative techniques, aesthetic designs, product labels, and various other information may be provided on such layers.

Embodiments of flexible panels 10 may be constructed using a “top to bottom” or “bottom to top” layering method. However, economies of manufacture may be realized by using a universal base composite layer and then selectively adding and orienting additional reinforcement layers in desired locations on the base composite layer so as to customize the panel to have the desired properties in particular zones of the panel (such as the zones of FIG. 1). By way only of example and with reference to FIG. 2, layers 20B-F are common to all five zones illustrated in FIG. 1. Thus, a base composite layer may be formed of these common layers. After formation, additional reinforcement layers (such as layers 20A and 20G in FIG. 2) may be added to the base composite layer to impart the desired properties to the resulting panel. By varying the type, number, and location of the reinforcement layers as well as the directionality of the fibers within such layers, the base composite layer is selectively reinforced such that the resulting panel may be more flexible in some areas and stiffer in others.

In some embodiments, the layer orientation within any zone of the flexible panel 10 is symmetrical such that the same number of layers is provided on each side of the centermost layer in an odd-numbered layer construction. In the case of an even number of layers, the construction would be symmetrical about the central joining surface between the two innermost layers. However, such symmetry is not required.

The flexible panels disclosed herein may be produced in high volume, with low to no tooling costs. They are easily customized and may be provided in any size, shape, or geometry using standard cutting technology. They are lightweight, fatigue resistant, impact resistant, and flame and/or smoke resistant.

FIG. 7 illustrates the layer 20C provided in the form of tape. In various other examples, various other layers of the flexible panel 10 may be provided as a tape.

Any of the above described components, parts, or embodiments may take on a range of shapes, sizes, or materials as necessary for a particular application of the described invention. The components, parts, or mechanisms of the described invention may be made of any materials selected for the suitability in use, cost, or ease of manufacturing. Materials including, but not limited to thermoplastics, thermoset plastics, glass fibers, carbon fibers, composites, or other polymers may be used to form any of the above-described components.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. A flexible panel having an area, a lateral direction, and a longitudinal direction, the flexible panel comprising a plurality of layers attached on top of each other, each of the plurality of layers having an area, at least some of the plurality of layers comprising a plurality of fibers encapsulated in a binder material in a fiber orientation, wherein the flexible panel further comprises:
a rigid zone having a rigid zone flexibility; and
a flex zone having a flex zone flexibility different from the rigid zone flexibility, wherein at least one of the plurality of layers or the fiber orientation of the plurality of layers is different between the rigid zone and the flex zone.

2. The flexible panel of claim 1, wherein the rigid zone has more layers than the flex zone.

3. The flexible panel of claim 1, wherein the fiber orientation of the plurality of fibers in at least one of the plurality of layers is uni-directional.

4. The flexible panel of claim 1, wherein the fiber orientation of the plurality of fibers in at least one of the plurality of layers is bi-directional.

5. The flexible panel of claim 1, wherein the fiber orientation of the plurality of fibers in at least one of the plurality of layers is aligned in a direction different from the longitudinal direction and the lateral direction of the flexible panel.

6. The flexible panel of claim 1, wherein the fiber orientation of a majority of the plurality of layers in the rigid zone is aligned with the longitudinal direction of the flexible panel.

7. The flexible panel of claim 1, wherein the fiber orientation of a majority of the plurality of layers in the flex zone is aligned with the lateral direction of the flexible panel.

8. The flexible panel of claim 1, wherein the area of at least one of the plurality of layers is less than the area of the flexible panel.

9. The flexible panel of claim 1, wherein the fiber orientation of at least two adjacent layers of the plurality of layers is different.

10. The flexible panel of claim 1, wherein at least one of the plurality of layers comprises a core of thermoplastic film, foam, honeycomb, organic materials, or microspheres.

11. The flexible panel of claim 1, wherein the flexible panel comprises at least two rigid zones separated by the flex zone.

12. A method of forming a flexible panel having an area, a longitudinal direction, a lateral direction, a rigid zone having a rigid zone flexibility, and a flex zone having a flex zone flexibility different from the rigid zone flexibility, the method comprising:
forming a base composite by attaching a plurality of common layers on top of each other, at least some of the plurality of common layers comprising a plurality of fibers encapsulated in a binder material in a fiber orientation; and
adding at least one reinforcement layer onto the base composite, the at least one reinforcement layer having an area that is less than the area of the flexible panel.

13. The method of claim 12, wherein adding the at least one reinforcement layer comprises adding a plurality of reinforcement layers onto the base composite.

14. The method of claim 13, wherein adding the plurality of reinforcement layers comprises adding more reinforcement layers to the rigid zone of the flexible panel than to the flex zone of the flexible panel.

15. The method of claim 12, wherein the at least one reinforcement layer comprises a plurality of fibers in a fiber orientation and encapsulated in a binder material, and wherein adding the at least one reinforcement layer onto the base composite comprises orienting the at least one reinforcement layer such that the fiber orientation of the fibers within the at least on reinforcement layer is aligned with the longitudinal direction of the flexible panel.

16. The method of claim 12, wherein forming the base composite comprises orienting the plurality of common layers such that the fiber orientation between two adjacent common layers is different.

17. The method of claim 12, wherein forming the base composite comprises orienting the plurality of common layers such that the fiber orientation of at least one of the plurality of common layers is aligned with the longitudinal direction of the flexible panel.

18. The method of claim 12, wherein forming the base composite comprises laminating and orienting the plurality of common layers such that the fiber orientation of at least one of the plurality of common layers is aligned with the lateral direction of the flexible panel.

19. The method of claim 12, wherein forming the base composite comprises orienting the plurality of common layers such that the fiber orientation of at least one of the plurality of common layers is aligned with the lateral direction of the flexible panel and such that the fiber orientation of another of the plurality of common layers is aligned with the lateral direction of the flexible panel.

20. The method of claim 12, wherein the at least one reinforcement layer comprises a plurality of fibers in a fiber orientation and encapsulated in a binder material, and wherein adding the at least one reinforcement layer onto the base composite comprises orienting the at least one reinforcement layer such that the fiber orientation of a first plurality of the fibers within the at least on reinforcement layer is aligned with the longitudinal direction of the flexible panel and the fiber orientation of a second plurality of the fibers within the at least one reinforcement layer is aligned with the lateral direction of the flexible panel.
